(19) United States
(12) Patent Application Publication
(10) Pub. No.: US 2017/0274577 A1
(43) Pub. Date: Sep. 28, 2017

(54) COMPOSITE STRUCTURES WITH STIFFENERS AND METHOD OF MAKING THE SAME

(71) Applicant: THE BOEING COMPANY, Chicago, IL (US)

(72) Inventors: Lauren Anne Burns, Melbourne (AU); Andrew Kenneth Glynn, Seattle, WA (US); Peter J. Lockett, Melbourne (AU); Max Marley Osborne, Melbourne (AU); David Andrew Pook, Melbourne (AU); Ronnie Karol Ligeti, Port Melbourne (AU); Samuel James Meure, Heatherton (AU)

(21) Appl. No.: 15/079,202

(22) Filed: Mar. 24, 2016

(51) Int. Cl. B29C 65/02; B64C 1/12; B64C 1/06; B29C 65/48

(52) U.S. Cl. CPC B29C 65/02; B29C 65/48; B64C 1/12; B64C 1/064; B29L 2031/3076

(57) ABSTRACT

A method for assembling a stiffened composite structure includes a step of positioning a plurality of dry fibers along a first side of a pre-preg composite laminate skin element wherein the pre-preg composite laminate skin element is dimensionally changeable. The method further includes a step of positioning an interlayer between the plurality of dry fibers and the first side of the pre-preg composite laminate skin element and a step of infusing the plurality of dry fibers with a resin forming a plurality of infused fibers. The method also includes a step of co-curing the pre-preg composite laminate skin element and the plurality of infused fibers.

### FIELD

This disclosure generally relates to composite structures, and more particularly to composite structures that include stiffener members and methods for making the same.

### BACKGROUND

It is sometimes necessary to reinforce composite structures, such as those used in aerospace industry in order to meet needed strength and/or stiffness requirements. These structures include, for example, a skin of an aircraft such as that of a wing and/or fuselage. Skin structures are lightweight and are often thin gauged panels which need added strength and stiffness. Other structures in the aerospace industry, as well as, structures in other industries also need additional strength and/or stiffness. Adding stiffeners to a composite structure, such as to a skin structure of an aircraft, provides the needed strength and rigidity for demands placed on the skin structure of the aircraft.

Traditionally in constructing a reinforced skin, one that comprises a skin and a stiffener or a stringer structure, various fabrication processes have been employed to construct the reinforced skins. In one fabrication process, laying up composite pre-preg material for both the skin and the stiffener structures has been used. Alternatively, fabrication processes have used infusion processes wherein dry fiber was infused with resin for the stiffener elements and dry fibers were infused homogeneously with resin for the skin panel elements.

Utilizing pre-preg was advantageous for purposes of constructing the skin element since composite pre-preg material promoted tight control of optimized fiber volumes for structural efficiency and provided the opportunity to utilize automated lamination equipment to reduce labor costs. The stiffener or stringer structure, on the other hand, required non-automated and expensive hand labor lamination processes. The stiffener often required complex geometries in configuring the stiffener or stringer structure element. Stringers demanded careful placement onto the skin element to avoid fiber waviness in the stiffener structure. Fiber waviness could otherwise reduce performance of the stiffener. Additional complications arose in the fabrication of the stiffener and skin elements both being fabricated by a pre-preg layup process. Use of traditional pre-preg material in this fabrication required high temperature and high pressure curing processes which could introduce undesired results in the finished product. These high temperature and high pressure cure requirements for pre-preg material have been in the more recent past been somewhat ameliorated with utilizing pre-preg material which cures at lower temperatures and lower pressures.

Other past methods for assembling a reinforced skin structure would include making both the skin and the stiffener or stringer structures being homogenously constructed, as mentioned above, from an infused fiber fabrication process with curing the two structures at the same time. The skin structure and the stiffener structure have different fiber configurations and arrangements. The different fiber configurations and arrangements introduce different demands on the infiltrating resin during the infusion process for both of these structures. These demands provide further complications for a homogeneous co-infusion process of both the skin and stiffener structures.

Other processes for fabricating, for example a wind turbine blade, includes an outer structure constructed of dry fibers being infused with resin and an inner structure being constructed of a layup pre-preg structure positioned within the outer structure. Both of these structures are thereafter co-cured. In this process unidirectional pre-preg material is positioned within or otherwise enveloped within a fiber fabric system. The fiber fabric system and the enveloped pre-preg material are then positioned within the confinement of a vacuum bag. Infusion of resin is performed on the fiber fabric system which surrounds the pre-preg element. The infused assembly is co-cured. In this process the pre-preg material forms a connection with the infused fiber bed which surrounds the pre-preg material.

In other fabrication processes, a pre-cured stiffener is fabricated separate and apart from a pre-cured pre-preg skin which has been fabricated with a laying-up process. The pre-cured stiffener structure and the pre-cured skin structure are joined with secondary bonding. The pre-cured stiffener and pre-cured skin structures need to be independently fabricated with geometrical precision to have the surfaces of each of these pre-cured structures properly complement one another and achieve the needed geometries of the assembled structure and to promote a secure secondary bonding together of the two structures.

### SUMMARY

An example of a method for assembling a stiffened composite structure includes a step of positioning a plurality of dry fibers along a first side of a pre-preg composite laminate skin element wherein the pre-preg composite laminate skin element is dimensionally changeable. The method further includes a step of positioning an interlayer between the plurality of dry fibers and the first side of the pre-preg composite laminate skin element and a step of infusing the plurality of dry fibers with a resin forming a plurality of infused fibers. The method further includes a step of co-curing the pre-preg composite laminate skin element and the plurality of infused fibers.

### BRIEF SUMMARY OF THE DRAWINGS

FIG. 1 is a perspective view of an aircraft;

FIG. 2 is a partial broken away perspective view of pre-preg composite laminate fuselage skin element of the aircraft of FIG. 1 with infused composite stiffener elements coupled to a pre-preg composite laminate fuselage skin element;

FIG. 3 is a flow chart for a method for assembling a stiffened composite structure including coupling an infused composite stiffener element to a pre-preg composite laminate skin element and co-curing these elements together;

FIG. 4 is a schematic exploded partial view of a layup for assembling the stiffened composite structure by the method set forth in FIG. 3; and

FIG. 5 is a schematic exploded cross section view of the stiffened composite structure assembled by the method for assembling the stiffened composite structure as set forth in FIG. 3.

### DESCRIPTION

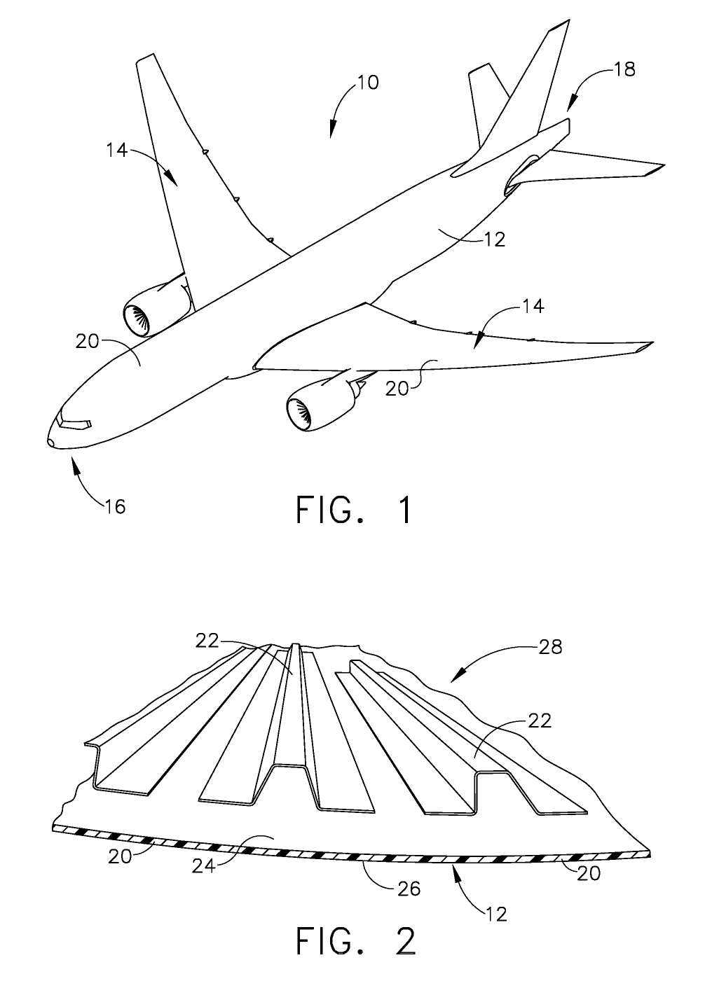

Referring to FIGS. 1 and 2, aircraft 10 includes structures of fuselage 12, wings 14, nose section 16 and tail section 18. Many of these structures of aircraft 10 are now constructed with composite materials. Composite materials provide beneficial properties to the structure of aircraft 10 with being lightweight and also providing strength. External portions of aircraft 10, such as, skin element or structure 20 of wings 14 and fuselage 12 are constructed of composite material having a generally panel shaped construction which is subjected to aerodynamic forces with aircraft 10 in operation. Additional strength to skin element or structure 20 is provided to resist these operational forces with the addition of coupling stiffeners 22, such as stringers, to skin structure 20.

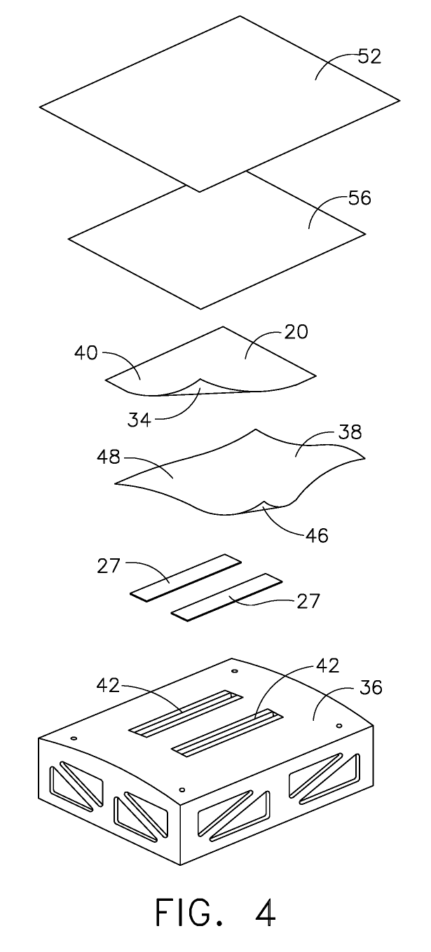

In referring to FIG. 2, pre-preg composite laminate skin element or structure 20, in this example, is a portion of the construction of fuselage 12. Stiffeners or stringers 22 are positioned on an internal surface 24 of pre-preg laminate composite skin element or structure 20 in order to provide additional strength to the pre-preg laminate composite skin element or structure 20 and at the same time not interfere with the aerodynamics of external surface 26 of the laminate composite skin structure 20 of aircraft 10. Stiffeners 22, to effectively provide the needed reinforcement to composite skin element or structure 20, need to closely follow the geometry of skin element or structure 20 which could include flat surfaces, curved surfaces and other complex geometries presented by skin structure 20 in the construction of structures such as fuselage 12 and wings 14 of aircraft 10. Automated equipment can be used in forming preforms of the plurality of dry fibers 27, as seen in FIG. 4, in fabricating stiffeners 22, to accurately and effectively provide the needed close following of the surface geometries of skin element 20. Automated assembly of the plurality of dry fibers 27 into preforms will additionally avoid unwanted wrinkling configurations of the fibers within the composite material of stiffener 22 which could otherwise affect strength performance of stiffener 22. As will be described herein, stiffeners 22 will be constructed with use of infusion of resin into a plurality of dry fibers 27 as seen for example in FIG. 4 and co-cured with pre-preg composite laminate skin element 20.

It will also be appreciated that employing automated equipment for assembling pre-preg composite laminate skin element or structure 20 is beneficial. Automation will provide labor cost savings for laying-up plies of pre-preg, as well as for, as mentioned above, accurate fabricating and positioning of the plurality of dry fibers into preforms for infused stiffeners 22.

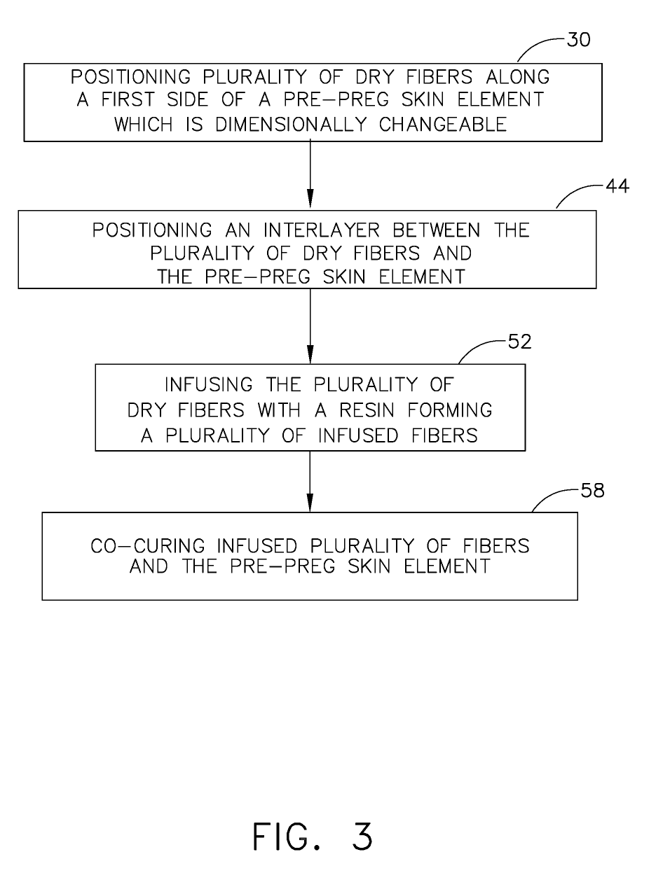

The method for assembling stiffened composite structure 28, as shown in FIG. 3 and described herein includes step 30 of positioning a plurality of dry fibers 27, as seen schematically in FIG. 4, along a first side 34 of a pre-preg composite laminate skin element 20 wherein the pre-preg composite laminate skin element 20 is dimensionally changeable. The method further includes step 44 of positioning an interlayer 38 between the plurality of dry fibers 27 and first side 34 of the pre-preg composite laminate skin element 20, as seen in FIG. 4. This method further includes step 52 of infusing the plurality of dry fibers 27 with a resin forming a plurality of infused fibers. The method further includes step 58 of co-curing the pre-preg composite laminate skin element 20 and the plurality of infused fibers. This method will be described in more detail herein.

The present method for assembling a stiffened composite structure 28 includes using a pre-preg composite laminate skin element 20 which is dimensionally changeable. Composite laminate skin element 20 can be constructed from one of a wide range of pre-preg composite laminate materials such as one of out of autoclave pre-preg and in-autoclave pre-preg. In either selection of pre-preg, the pre-preg will be in B Staging with respect to curing in starting this method which permits the laminate material to be dimensionally changeable to easily conform to a desired configuration.

Plies of pre-preg composite laminate skin 20 include fibers that are constructed of a material selected from one of a wide variety of materials such as glass, aramid, carbon, silicon carbide, boron, ceramic, metallic material E-glass (alumino-borosilicate glass), S-glass (alumino silicate glass), pure silica, borosilicate glass, optical glass and other glass compositions. Similarly, the plies are constructed of a resin selected from a wide variety of resins such as epoxies, bismaleimides, polyurethanes, phenolics, polyimides, sulphonated polymer (polyphenylene sulphide), a conductive polymer (e.g., polyaniline), benzoxazines, cyanate esthers, polyesters and silsesquioxanes resins which may also include toughening additives or components such as thermoplastics or silicon or other particles. The laminate can be assembled with a number of plies that are needed for the construction of a particular composite element or structure and the fiber orientation for each ply can be positioned as needed for the construction of a particular composite element or structure as well.

As mentioned above, one of a wide variety of pre-preg laminate composite materials can be employed for construction of skin element 20 of stiffened composite structure 28. One category of composite materials includes in-autoclave pre-preg composite laminate material which utilizes higher temperatures and higher pressures for curing of the composite laminate material than another category of composite laminate materials which includes out of autoclave composite laminate material. With use of in-autoclave composite laminate material in Step 58 of FIG. 3 of co-curing the plurality of infused fibers and the pre-preg composite laminate skin element 20, otherwise these assembled components are referred to as stiffened composite structure 28, co-curing utilizes pressures in a range that includes forty five pounds per square inch (45 psi) up to and including one hundred pounds per square inch (100 psi) and temperatures up to and including four hundred degrees Fahrenheit (400° F.). In utilizing in-autoclave pre-preg materials for stiffened composite structure 28, care needs to be taken so as to avoid introduction of defects in fabrication of composite stiffened structure 28 with using these higher curing temperatures and pressures.

Out of autoclave composite laminate pre-preg material can be used for constructing stiffened composite structure 28. At the time of employing step 52, as seen in FIG. 3, of infusing the plurality of dry fibers 27 with a resin, depending on the resin used, step 52 of infusing further includes a step of applying heat. The heat is applied to the infusion of resin and the plurality of dry fibers 27 and to the pre-preg composite laminate skin element 20 at the time of employing step 52 of infusing. The application of heat causes the pre-preg composite laminate skin element 20 to undergo an intermediate cure stage. The application of the heat elevates the temperature to these components of stiffened composite structure 28 to a range that would include one hundred and forty degrees Fahrenheit (140° F.) up to an including a temperature of two hundred and eighty degrees Fahrenheit (280° F.). After the intermediate cure stage is attained, step 58 of co-curing the out of autoclave pre-preg composite laminate skin element 20 and the plurality of infused fibers of stiffener 22 is employed. Step 58 of co-curing includes bringing skin element 20 and stiffener 22 to a final cure by heating the skin element 20 and stiffener 22 to a temperature of including two hundred and eighty degrees Fahrenheit (280° F.) up to and including four hundred degrees Fahrenheit (400° F.) and applying a pressure within a pressure range of which includes atmospheric pressure up to and including forty five pounds per square inch pressure (45 psi). The utilization of the out of autoclave pre-preg composite material is less likely to introduce defects to stiffened composite structure 28.

In referring to FIG. 3, the method for assembling a stiffened composite structure 28 includes step 30, as mentioned above, of positioning a plurality of dry fibers 27 along first side 34 of pre-preg composite laminate skin element 20, as seen in FIG. 4. The pre-preg composite material of the pre-preg composite laminate skin element 20 is dimensionally changeable which permits skin element 20 to conform to a desired configuration. The plurality of dry fibers 27 are configured to be one of braided, woven, unidirectional, non-crimped and other known fiber formats. In this example plurality of dry fibers 27 are configured in a braided configuration. As discussed above, plurality of these braided dry fibers 27, can be braided or otherwise configured by automated equipment and positioned for reliable conformity to flat, curved and other complex geometries presented by pre-preg composite laminated skin 20 at a low cost. The use of automated equipment and mandrels, if needed, promotes dimensional accuracy of stiffener 22 and reduces the occurrence of unwanted fiber waviness. The composition of the plurality of dry fibers 27 are selected from fibers constructed of one of a number of compositions as set forth and identified above for examples of fiber compositions for the pre-preg composite laminate material. In this example, carbon fibers are employed for dry fibers 27.

Step 30, of the method includes positioning plurality of dry fibers 27 along a first side 34 of pre-preg composite laminate skin element 20. In this example, the plurality of braided dry fibers 27 in a preform is used in fabricating stiffener 22 of stiffened composite structure 28 for the fabrication of portions of aircraft 10, such as, a fuselage 12, wings 14, nose section 16 and tail section 18 and the like as well as all associated elements of aircraft 10. The plurality of braided dry fibers 27 are positioned, in this example, along less than an entire surface of a first side 34 of pre-preg composite laminate skin element 20, as seen in FIG. 2, This positioning of the plurality of braided dry fibers 27 provides for selected positioning of resulting stiffeners 22 for strategic reinforcement of skin element 20.

Step 30 of positioning plurality of dry fibers 27, further includes positioning plurality of dry fibers 27, as mentioned above, along first side 34 of skin element 20. One example of first side 34 configuration includes a flat surface, not shown, wherein the plurality of dry fibers 27 may include being configured in a degree of twist about a first axis (not shown) of less than ten degrees per inch (10° per inch) wherein the first axis extends generally parallel to the flat surface. In other examples, first side 34 of the pre-preg composite laminate skin element 20 may include a curved surface, as seen in FIG. 2. The plurality of dry fibers 27 may include being configured in a degree of twist about a first axis (not shown) of less than ten degrees per inch (10° per inch) wherein the first axis extends generally parallel to the curved surface. The plurality of dry fibers 27 may also include configuring the plurality of dry fibers 27 into a configuration having a radius of less than four hundred inches (400 inches) about a second axis (not shown) wherein the second axis extends in a direction perpendicular to a tangent of the curved first side 34. This positioning of the plurality of dry fibers 27, for constructing stiffener 22 in step 30 includes accommodating a wide range of first side 34 surface configurations for skin element 20 to include very tight curves, gentle curves, flat or straight surfaces and complex geometrical surface configurations of first side 34.

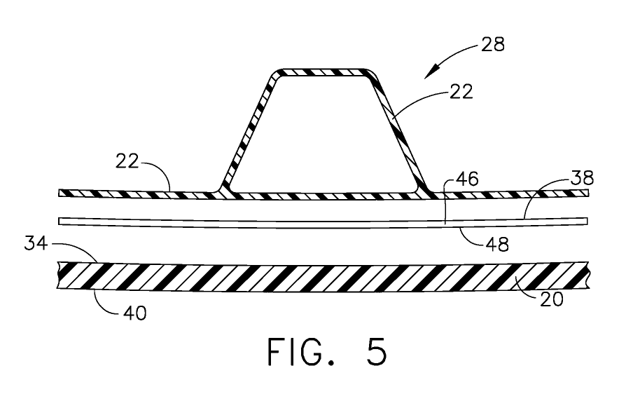

FIG. 4 portrays, as mentioned above, an exploded schematic view of the assembling of stiffened composite structure 28 with the use of layup tool 36, as will be described in more detail below. In referring to FIG. 4, stiffened composite structure 28, in this example, is assembled in an upside down arrangement in contrast to the finished assembled stiffened composite structure 28 as shown in schematic exploded view in FIG. 5, which has an opposite direction of orientation than shown in FIG. 4. In FIG. 5, first side 34, as seen in FIG. 4, of pre-preg composite laminate skin element 20 faces the direction of plurality of dry fibers 27 which are positioned to be within infused stiffener 22, wherein first side 34 will be the side of skin element 20 on which stiffener 22 will be positioned. Second opposing side 40 of pre-preg composite laminate skin element 20 will be positioned to face an outer portion of aircraft 10.

As described earlier automated equipment and, if needed, mandrels will position and configure the plurality of dry fibers 27, which form, in this example, preforms with needed precision in assembling stiffener 22 of composite stiffener structure 28. The preform of plurality of dry fibers 27 will conform to various configurations geometries of surfaces of first side 34 of skin element or structure 20, as discussed above and will avoid unwanted wrinkling configurations of the plurality of fibers within stiffener 22 which could otherwise affect strength performance of stiffener 22. Furthermore, in assembling stiffened composite structure 28, the plurality of fibers 27 are, in this example, positioned into slots 42 in layup tool 36, as shown in FIG. 4. In this example, layup tool 36 is an inner mold line “IML” tooling, in other examples, such tooling can include outer mold line tooling “OML” (not shown), so as to assist in providing a needed geometry for plurality of braided dry fibers 27 in assembling stiffened composite structure 28.

Step 44 of the method for assembling stiffened composite structure, includes, as seen in FIGS. 3 and 4, positioning an interlayer 38 between plurality of dry fibers 27 and first side 34 of pre-preg composite laminate skin element 20. In this example, one of two general types of interlayer 38 constructions are employed. Interlayer 38 is constructed of a permeable barrier construction or of an impermeable barrier construction. An impermeable interlayer 38 could include one of various constructions such as an adhesive film, textured film and bi-layer film. The impermeable interlayer 38 provides a gas and resin barrier between resin being infused to dry fibers 27 and the pre-preg composite laminate skin element 20. A permeable interlayer 38 includes interlayer 38 defining a plurality of perforations (not shown) which extend through interlayer 38. Permeable interlayer 38 similarly includes one of various constructions such as a perforated adhesive film, perforated textured film, perforated bi-layer film and a veil.

An adhesive film is an interlayer adhesive that is typically supplied in sheet format and is able to chemically bond to components on either side of the adhesive film as well as provide a consistent bond thickness and strength. A textured film has a three dimensional surface which provides for mechanical interlocking with the infused resin for stiffener 22 and with the resin of pre-preg composite laminate skin element 20. A bi-layer film provides chemical specific surfaces for the film to provide an enhanced chemical securement with the infused resin on one side of the bi-layer film and an enhanced chemical securement with the pre-preg resin on an opposing side of the bi-layer film. A veil is a mat of spun fiber in a random or specific pattern and provides a high-toughness interface between pre-preg and resin infused layers once resin from adjacent layers has permeated through it. These various examples of interlayers 38 can be utilized to optimize securement in the co-curing process between resin of stiffener 22 and resin of pre-preg composite laminate skin element 20.

As seen in FIG. 4, first side 46 of interlayer 38 will be positioned such that plurality of dry fibers 27 contact first side 46. Second opposing side 48 of interlayer 38 will be positioned in contact with or positioned onto first side 34 of pre-preg composite laminate skin element 20. In this example, step 44 of positioning interlayer 38 between plurality of dry fibers 27 and first side 34 of skin element 20 is implemented, prior to positioning plurality of dry fibers 27 within a resin barrier 52, as seen in FIG. 4. In this example, step 44 of positioning interlayer 38 is also implemented prior to implementing step 52 of infusing plurality of dry fibers 27 with a resin forming a plurality of infused fibers. Once plurality of dry fibers 27 are infused with resin, step 58 co-curing infused plurality of infused fibers and pre-preg composite laminate skin element 20 is employed as discussed herein.

When co-curing a pre-preg skin element 20 and resin infused stiffener 22, dissimilarities arise with respect to dissimilar chemistries and viscosities of the resins of skin element 20 and stiffener 22. For example, this may occur when combining a burn resistant outer layer using a Benzoxanine pre-preg resin chemistry in combination with a low viscosity, high strength and contour inner layer epoxy infusion resin chemistry. Another example occurs when combining a tough and impact resistant outer layer by using a Cyanate Ester pre-preg resin chemistry in combination with a low viscosity, high strength and contour inner layer epoxy infusion resin chemistry.

Interlayer 38 facilitates co-curing infused fibers and pre-preg composite laminate skin element 20 having differing resin chemistries. For example, an impermeable interlayer 38 which is a bi-layer film can provide functional groups that bond with one resin chemistry on one side of the interlayer 38 and different functional groups that bond with the other resin chemistry on the other side of the interlayer 38. Impermeable interlayers 38 such as bi-layer film provide additional characteristics such as being a gas barrier to prevent out-gassing from, for example, the pre-preg affecting the quality of the infusion resin being used with forming stiffener 22. Impermeable bi-layer film also functions as a resin barrier to prevent pre-preg resin bleeding into plurality of dry fibers 27 of stiffener 22. Pre-preg bleeding of resin into infused resin or bleeding of the infused resin into pre-preg 20 resin can cause disruption of the resin chemistries of pre-preg skin element 20 and of the infused resin chemistry of stiffener 22.

Other impermeable interlayers 38 can be employed such as textured films, for example, which have three dimensional surfaces that provide mechanical interlocking between the resin positioned on opposing sides of interlayer 38. Use of compatible or non-compatible functional groups of resins can be used on either side of textured interlayer 38. These impermeable textured interlayers 38 which facilitate mechanical interlocking also because they are impermeable additionally function as a gas barrier, as well as, a resin barrier.

An impermeable adhesive film, such as Metlbond1515, provides chemical curing to resin positioned on opposing sides of interlayer 38. Use of compatible functional groups of resins are required in the materials on either side of textured interlayer 38.

A veil is comprised of spun fibers, for example, polymer or carbon that can be either looped randomly or manufactured to create a specific pattern. The areal weight (weight/area) is a measure of veil fiber density, which impacts the veil permeability. A veil is bonded onto plies and is located at an interlayer position in a stack. A veil is multi-functional and stabilizes the dry format carbon fiber material and toughens the bond-line by inhibiting crack growth allowing the part to absorb more energy and deform without fracturing.

Interlayer 38 can also be configured to be permeable, wherein interlayer 38 defines perforations or pores (not shown) with a particular perforation or pore size and distribution to control resin permeability. Physical bonding occurs with the resins penetrating perforations of interlayer 38. In utilizing permeable interlayer 38, the pore or perforation size is selected to work in conjunction with resin viscosity. The resin viscosity is controlled by temperature cure profile to allow each resin to flow into interlayer 38 but not continue to flow beyond interlayer 38 and mix with a dissimilar resin in instances where the resins are not compatible.

In one example of permeable interlayer 38 a bi-layer film can be employed which has two types of functional groups distributed one on each side of interlayer 38. One functional group that bonds with pre-preg 20 resin chemistry and another different functional group that bonds with the infused resin chemistry. Chemical bonding of resin chemistry of each of the infused resin and the pre-preg resin occurs at functional group sites positioned on opposing sides of bi-layer film interlayer 38. Use of a permeable bi-layer film interlayer 38 is beneficial for securing resin of infused fibers 27 to interlayer 38 on one side of interlayer 38 and securing resin of pre-preg on the opposing side of interlayer 38 where the resins on each side of interlayer 38 are incompatible in forming a secure chemical interlocking. In another example, a textured interlayer 38 may be selected for purposes of forming mechanical interlocking with resins positioned on opposing side of interlayer 38. Other examples of permeable interlayer 38 include a perforated adhesive film a polyamide veil of predetermined areal weight.

There are occurrences where the functional chemistries of the two different resins from the infused fibers and pre-preg 20 are compatible such that they can be combined. The use of permeable interlayers 38 can be employed such that the two resins can chemically bond and secure to one another with the resins accessing each other through the perforations of the permeable interlayer 38. For example, such may occur in production of high impact toughness outer skin pre-preg element 20 with highly contoured resin infused stiffener 22. Tough resin formulations typically have high viscosity unsuitable for resin infusion processing. High contour geometries are more easily produced using a dry fiber preform that is subsequently infused with resin. An example would be an Amine curing epoxy pre-preg material combined with an Amine curing epoxy infusion resin.

An impermeable interlayer 38 may be selected in instances where two different resins are not particularly compatible. The impermeable interlayer 38 can act as a gas and resin barrier and will bond to the same functional group resins positioned on either side of interlayer 38 in the use of a bi-layer film interlayer 38 or with the implementation of an impermeable textured interlayer 38 can be selected which will facilitate mechanical interlocking to the incompatible resins Impermeable adhesive film interlayer 38 that will bond to both resin chemistries and provide an impermeable barrier to keep the resins separate can be employed as well.

Alternatively, a permeable interlayer 38, such as bi-layer film, adhesive film, textured film or a veil can be employed in instances where the resins positioned on opposing sides of interlayer 38 are compatible with similar functional group chemistry and permitted to engage through the perforations of interlayer 38 and can be employed where the resins are not particularly compatible with dissimilar functional group chemistry but are used under controlled circumstances of not permitting the resins positioned on opposing sides of interlayer 38 to intermix.

With infusion of plurality of dry fibers 27, first side 46 of interlayer 38 during the co-curing process secures to the infused fibers which were formerly plurality of braided dry fibers 27. Also, during the co-curing process, second opposing side 48 of interlayer 38 secures to first side 34 of pre-preg composite laminate skin element 20. Interlayer 38 serves in providing a robust mechanical bond between the two elements, pre-preg skin 20 and composite stiffener 22, that may contain compatible or different resin systems which may or may not otherwise provide a chemical bond.

The method for assembling a stiffened composite structure 28, as mentioned earlier, further includes positioning plurality of braided dry fibers 27 within resin barrier 52. In this example, resin barrier 52 may include a consumable such as vacuum bagging film. In this example, caul plate 56 is also positioned within resin barrier 52. A vacuum is applied, to the interior of the bagging film and its contents and an infusion resin such as an epoxy or other suitable infusible resin for fabricating stiffener 22, is drawn into resin barrier or bagging film 52 carrying out step 54 of infusing the plurality of dry fibers 27 with resin. As a result, an infused composite stiffener 22 is formed that is positioned in contact with interlayer 38, as can be seen in FIG. 4.

With the plurality of fibers infused forming infused stiffener 22, step 58 of co-curing infused plurality of fibers 27 and pre-preg composite laminate skin element 20 is carried out thereby coupling infused fibers of composite stiffener 22 to pre-preg composite laminate skin element 20 with interlayer 38 positioned there between. Step 58 of co-curing infused composite stiffener 22 and pre-preg composite laminate skin element 20 includes, in this example, applying heat to infused composite stiffener 22 and pre-preg composite laminate skin element 20 and applying pressures, as discussed in detail earlier, for the curing of the in-autoclave pre-preg composite laminate skin element 20 and for the curing of the autoclave pre-preg composite laminate skin element 20. The heat and pressure parameters discussed above would be used in co-curing the stiffener 22 and skin element 20.

While various embodiments have been described above, this disclosure is not intended to be limited thereto. Variations can be made to the disclosed embodiments that are still within the scope of the appended claims.

What is claimed:

1. A method for assembling a stiffened composite structure, comprising the steps of:
positioning a plurality of dry fibers along a first side of a pre-preg composite laminate skin element wherein the pre-preg composite laminate skin element is dimensionally changeable;
positioning an interlayer between the plurality of dry fibers and the first side of the pre-preg composite laminate skin element;
infusing the plurality of dry fibers with a resin forming a plurality of infused fibers; and
co-curing the pre-preg composite laminate skin element and the plurality of infused fibers.

2. The method for assembling a stiffened composite structure of claim 1, wherein the step of positioning the plurality of dry fibers further includes the plurality of dry fibers comprise a configuration of one of braided, woven, unidirectional and non-crimped fibers.

3. The method for assembling of claim 1, wherein the step of positioning the plurality of fibers along the first side of the pre-preg composite laminate skin element further includes positioning the plurality of dry fibers to extend along less than an entire area of the first side of the pre-preg composite laminate skin element.

4. The method for assembling of claim 1, wherein the step of positioning the plurality of dry fibers further includes the first side of the pre-preg composite laminate skin element comprises a flat surface.

5. The method for assembling of claim 4, wherein the step of positioning the plurality of dry fibers includes configuring the plurality of dry fibers into a configuration having a degree of twist about a first axis of less than ten degrees per inch (10° per inch).

6. The method for assembling of claim 1, wherein the step of positioning the plurality of dry fibers further includes the first side of the pre-preg composite laminate skin element comprises a curved surface.

7. The method for assembling of claim 6, wherein the step of positioning the plurality of dry fibers includes configuring the plurality of dry fibers into a configuration having a degree of twist about a first axis of less than ten degrees per inch (10° per inch).

8. The method for assembling of claim 6, wherein the step of positioning the plurality of dry fibers includes configuring the plurality of dry fibers into a configuration having a radius of less than four hundred inches (400 inches) about a second axis.

9. The method for assembling of claim 1, wherein the step of positioning an interlayer between the plurality of dry fibers and the pre-preg composite laminate skin element further includes the interlayer comprising an impermeable barrier.

10. The method for assembling of claim 9, wherein the step of positioning an interlayer between the plurality of dry fibers and the pre-preg composite laminate skin element further includes the interlayer comprising one of an adhesive film, textured film, bi-layer film and a veil.

11. The method for assembling of claim 1, wherein the step of positioning an interlayer between the plurality of dry fibers and the pre-preg composite laminate skin element further includes the interlayer comprising a permeable barrier.

12. The method of assembling of claim 11, wherein the step of positioning an interlayer between the plurality of dry fibers and the pre-preg composite laminate skin element further includes the interlayer defining a plurality of perforations.

13. The method for assembling of claim 12, wherein the step of positioning an interlayer between the plurality of dry fibers and the pre-preg composite laminate skin element further includes the interlayer comprising one of an adhesive film, textured film, bi-layer film and a veil.

14. The method for assembling of claim 1, further including a step of positioning the plurality of dry fibers into a resin barrier prior to the step of infusing the plurality of dry fibers with the resin.

15. The method for assembling of claim 1 wherein the step of positioning an interlayer between the plurality of dry fibers and the pre-preg composite laminate skin element further includes the pre-preg composite laminate skin element comprises an out of autoclave pre-preg composite.

16. The method for assembling of claim 15, wherein the step of infusing further includes a step of applying heat to infusion of resin and the plurality of dry fibers and to the pre-preg composite laminate skin element such that the pre-preg composite laminate skin element undergoes an intermediate cure stage.

17. The method for assembling of claim 16, wherein the step of co-curing further includes a step of applying a pressure to the plurality of infused fibers and the pre-preg composite laminate skin element within a pressure range of which includes atmospheric pressure up to and including forty five pounds per square inch pressure (45 psi).

18. The method for assembling of claim 16, wherein the step of co-curing further includes heating the plurality of infused fibers and the pre-preg composite laminate skin element to a temperature within a range including two hundred and eighty degrees Fahrenheit (280° F.) up to and including four hundred degrees Fahrenheit (400° F.).

19. The method for assembling of claim 1, wherein the step of positioning an interlayer between the plurality of dry fibers and the pre-preg composite laminate skin element further includes the pre-preg composite laminate skin element comprises an in-autoclave pre-preg composite.

20. The method for assembling of claim 19, wherein the step of co-curing further includes a step of applying a pressure to the plurality of infused fibers and the pre-preg composite laminate skin element within a pressure range of which includes forty five pounds per square inch pressure (45 psi) up to and including one hundred pounds per square inch (100 psi) and heating the plurality of infused fibers and the pre-preg composite laminate skin element to a temperature up to and including four hundred degrees Fahrenheit (400° F.).
